(19) United States
(12) Patent Application Publication
(10) Pub. No.: US 2008/0017335 A1
(43) Pub. Date: Jan. 24, 2008

(54) ROLL-UP WINDOW BLIND ASSEMBLY FOR MOTOR VEHICLES

(76) Inventors: Thomas Pohl, Grossenseebach (DE); Hans Herzog, Hirschaid (DE); Harald Kruger, Erlangen (DE); Werner Stammberger, Grub (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/773,687

(22) Filed: Jul. 5, 2007

(30) Foreign Application Priority Data
Jul. 19, 2006 (DE) 20 2006 011 248.0

(51) Int. Cl. B60J 1/20

(52) U.S. Cl. 160/370.22

(57) ABSTRACT

Roll-up window blind assembly for motor vehicles comprising a roll-up window blind near a window pane and an adjusting mechanism disposed underneath the window pane for drawing off a blind material from a winding body, which is joined to the lower end of a power transmission means, the upper end of which is linked to a pull rod joined to the upper edge of the blind material to draw said material off. Assembly further comprises guide means for guidance of the power transmission means. To effectively prevent vibration of the blind material against the window pane, the guide means controls a path of the power transmission means whereby, during the drawing, the upper end of the power transmission means moves towards or contacts the window pane and moves along or in contact with the window pane on further drawing-off of the blind material.

The present application claims the priority of German utility model no. DE 20 2006 011 248.0 “Roll-up window blind assembly for motor vehicles and vehicle door”, filed on 19 Jul. 2006, the content of which is expressly included in the present application by way of reference.

### FIELD OF THE INVENTION

The present invention relates to a roll-up window blind assembly with a roll-up window blind for covering window panes to afford privacy or protection against glare and relates in particular to a roll-up window blind assembly in which the blind material is prevented from fluttering or vibrating against the window pane even in positions other than the uppermost limit position of said blind material.

### BACKGROUND OF THE INVENTION

The use of roll-up window blinds for covering window panes to afford privacy or protection against glare has long been known from the prior art, namely as an alternative to the use of height-adjustable visors such as are disclosed in German patent applications DE 199 24 620 A1 or DE 10 2004 051 931 A1. Roll-up window blinds are lighter and less expensive and require less installation space, which is particularly advantageous for affording privacy or protection against glare in the region of the side windows. However, the flexible, windable material of a roll-up window blind requires particular guidance so that the web-like blind material can be reeled out and reeled in again without creasing.

European patent application EP 1 123 824 A2, corresponding to US patent application US 2001/0022218 A1, discloses a side window roll-up blind for motor vehicles having a winding shaft, which is rotatably supported, and an actuating means to unreel the blind material from the winding shaft. The side window roll-up blind is guided in at least one guide rail at a distance from the door or window frame. The guide rail assembly lends the side window roll-up blind a certain stability in order to counteract fluttering or vibration of the side window roll-up blind against the associated window pane. Also disclosed is an embodiment without guide rails in which two slide guide blocks are fixed at a distance from each other underneath the winding shaft on the door, from which a pressure-resistant and relatively bending-resistant cylindrical actuating member exits upwards in order to push a pull rod joined to the upper edge of the blind material ahead of it. This construction is, however, comparatively complex and cannot reliably prevent vibration or fluttering of the blind material.

German patent application DE 10 2004 009 874 A1, which corresponds to WO 2005/082656 A1, discloses a roll-up window blind which is driven by a cable window lift. The cable window lift incorporates a further adjusting member such that one and the same drive can be used for adjusting both a side window and the roll-up window blind. The roll-up window blind is guided in two guide rails at a distance from each other which are disposed in the door or window frame. This arrangement is also comparatively complex. The guide rails may also be considered annoying.

German Utility Model DE 20 2004 014 652 U1 discloses a roll-up window blind assembly of the type claimed by the present invention. A tab is guided in a window lift guide rail. The window lift tab is joined to the lower end of a power transmission means, the upper end of which is linked to a pull rod, said pull rod being joined to the top edge of the blind material. By moving the tab upwards, the blind material is drawn off a winding body pretensioned by means of a torsional spring. According to a first embodiment, the blind material is guided by guide rails provided laterally on the window aperture. Also disclosed is an embodiment, in which a guide element additionally guides a pressing rod acting as a power transmission member at the upper end of the window lift guide rail such that rigid guidance of the blind material is guaranteed during complete or partial covering of the window pane even without lateral guide rails, as described previously. Vibration or fluttering of the blind material is, however, only reliably prevented in a topmost position of the roll-up window blind, in which the pull rod is hooked in on the top edge of the window aperture or is secured in another manner.

### SUMMARY OF THE INVENTION

The object of present invention is to provide a roll-up window blind assembly with a simple, inexpensive construction in which the blind material is prevented from fluttering or vibrating against the window pane even in positions other than the uppermost limit position of said blind material. In accordance with further aspects of the present invention, the intention is to provide for crease-free reeling out and reeling in of the blind material by a winding body in addition to the provision of a vehicle door with a roll-up window blind assembly of the aforementioned type.

According to the invention, the guide means is configured to control a path of the power transmission means on drawing off the blind material such that, at the beginning of drawing the blind material off the winding body, the upper end of the power transmission means moves towards the window pane or is brought into contact with it and moves along the window pane or continues to be held in contact with it on further drawing-off of the blind material. Overall, the upper edge of the blind material, in particular the pull rod provided in this region, is thus already brought into immediate proximity with the window pane or preferably into contact therewith during a first phase of drawing the blind material off the winding body such that overall it is possible to prevent fluttering or vibration of the blind material on the window pane over a large part of the blind material's drawing-off path.

According to a preferred embodiment, the upper edge of the blind material or the pull rod provided in this region is quickly brought into contact with the window pane after exiting the door's top shoulder area and during the whole further course of the blind material's drawing-off path is moved further upwards in contact with the window pane until the upper edge of the window pane is reached.

This may be brought about by using an appropriate bending-resistant but nevertheless sufficiently elastic pressing rod as the power transmission means and/or by appropriate control of the blind material's drawing-off path.

According to a further embodiment, for better support of the blind material's upper edge, preferably of the pull rod provided in this region, sliding elements may be provided which are brought into contact with the window pane and are moved in a sliding manner in contact with the window pane during further drawing-off of the blind material.

According to a further embodiment, for appropriate control of the drawing-off path, a guide means is provided in the form of a slot or an oblong eye, wherein a pressing rod acting as a power transmission means is guided movably in a first direction parallel to or along the guide rail and is guided in close contact in a second direction, perpendicular to the first direction, that is to say facing outwards from the vehicle. In particular, in case the window pane is inclined or curved outwards from the vehicle and/or the window pane cuts an imaginary elongation line of a guide rail of the adjusting mechanism controlling the movement of the pressure rod, such a guide means ensures a compensation along the lower edge of the window pane in order to enable crease-free reeling out and reeling in of the blind material.

According to a further embodiment, alternatively or in addition to the aforementioned guide means, a hole, preferably a round hole or an eye, may be provided as a guide means, wherein the pressing rod is guided so as to be slidably movable and in close contact during drawing-off of the blind material. In such an embodiment, a compensating means is preferably provided in order to prevent excessive contact pressure of the pressing rod and/or of the pull rod on the window pane during further drawing-off of the blind material. At the same time it is possible to bring about accurate control of the pressure rod's drawing-off path especially in combination with a guide rail formed so as to be curved at least in sections, said rail guiding a lower end of the pressing rod such that the upper end of the pressing rod initially moves towards the window pane or comes into contact with it at the beginning of drawing the blind material off the winding body and moves along the window pane or continues to be held in contact with it on further drawing-off of the blind material.

### OVERVIEW OF FIGURES

The invention will be described in the following in an exemplary manner and with reference to the associated drawings, from which further features, advantages and objects to be achieved can be seen. The figures show:

FIG. 1 in a schematic side view, the schematic construction of a roll-up window blind assembly according to the present invention;

FIGS. 2a and 2b in a schematic side view and a sectional view, a roll-up window blind assembly according to a first embodiment of the present invention;

FIGS. 3a and 3b in a side view and a sectional view, a roll-up window blind assembly according to a second embodiment of the present invention;

FIGS. 4a and 4b in a side view, a roll-up window blind assembly according to a third embodiment of the present invention in a completely lowered and a reeled-out state of the blind material;

FIG. 5a in a schematic side view, an upper section of a roll-up window blind assembly according to the present invention;

FIG. 5b in a schematic sectional view, the upper region of a roll-up window blind assembly according to a further embodiment of the present invention;

FIGS. 6a and 6b in a side view and in a sectional view, the upper region of a roll-up window blind assembly according to a further embodiment of the present invention;

FIGS. 7a to 7c in a side view and in two sectional views, the upper region of a roll-up window blind assembly according to a further embodiment of the present invention in a topmost end position and a lowered position;

FIGS. 8a to 8c in a side view and in two upper sectional views, a roll-up window blind assembly according to a further embodiment of the present invention;

FIG. 9a in a schematic side view, a roll-up window blind assembly according to a further embodiment of the present invention;

FIGS. 9b and 9c in a schematic side view and an upper sectional view, the roll-up window blind assembly according to FIG. 9a;

FIGS. 10a and 10b in a schematic side view and in a sectional view, a roll-up window blind assembly according to a further embodiment of the present invention;

FIGS. 11a to 11c a roll-up window blind assembly according to a further embodiment of the present invention;

FIGS. 12a to 12c a roll-up window blind assembly according to a further embodiment of the present invention;

FIGS. 13 to 15 various examples for the integration of a roll-up window blind assembly according to the invention into a vehicle door;

FIGS. 16 and 16b in a schematic side view and in an enlarged sectional view, a roll-up window blind assembly according to a further embodiment of the present invention;

FIGS. 17a to 17c a roll-up window blind assembly according to a further embodiment of the present invention;

FIG. 18 a roll-up window blind assembly according to a further embodiment of the present invention with two lateral guide rails on the margin of a window aperture;

FIG. 19 a roll-up window blind assembly according to a further embodiment of the present invention;

FIG. 20a a roll-up window blind assembly according to a further embodiment with two tabs but without guide rails;

FIG. 20b a modification of the embodiment according to FIG. 20a with two guide rails at a distance from each other for guidance of the tabs; and

FIG. 21 a roll-up window blind assembly according to a further embodiment of the present invention.

### Identical reference numerals in the Figures indicate identical or substantially equivalent elements or element groups.

### DETAILED DESCRIPTION OF PREFERRED EMBODIMENTS

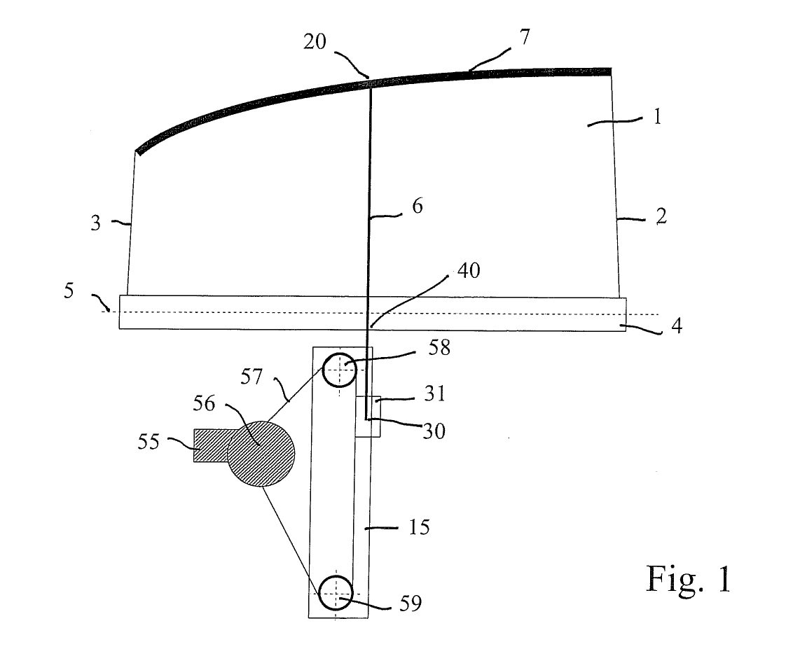

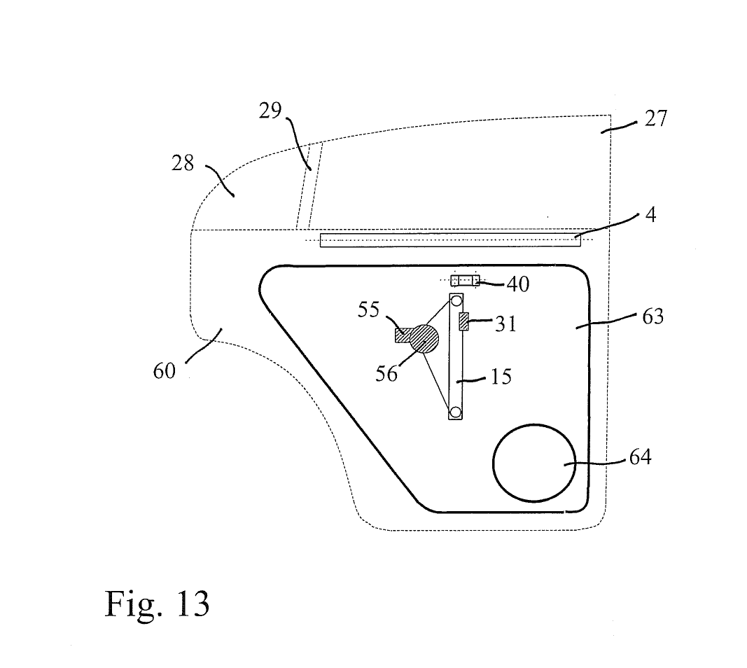

FIG. 1 shows in a schematic side view, a roll-up window blind assembly for the side window of a motor vehicle door having a window pane, which can be lifted and lowered, and a triangular side window separated therefrom by an intermediate ligament (cf. FIG. 13). According to FIG. 1, a single-strand cable window lift is provided to adjust roll-up window blind 1. The cable window lift has a tab 31 movably supported in a window lift guide rail 15 which supports the lower end of pressing rod 6 acting as a power transmission means. A control cable 57 forms a closed cable loop which is guided in window lift guide rail 15 by way of a top and a bottom cable deflection device 58, 59, preferably formed as cable deflection rollers. For actuation of the cable window lift there is provided a window lift drive 55, which is made up for example of an electric motor with gears and a cable drum 56, which the ends of control cable 57 are wound up onto. Window lift tab 31, disposed in a cable strand between top cable deflection roller 58 and bottom cable deflection roller 59, is moved upwards or downwards when cable drum 56 turns in one or the other direction of rotation such that roll-up window blind 1 is correspondingly raised or lowered. Control cable 57 may be guided completely or in sections in a sheath and accordingly form a Bowden cable. The cable window lift thus formed may be provided specially for adjusting the roll-up window blind, but may also alternatively be used for adjusting a height-adjustable side window. For joint use of one and the same drive for adjusting a window pane and a roll-up window blind, an adjusting member may be built into the cable window lift, for example in the manner described in German Utility Model DE 10 2004 009 874 A1, the content of which is expressly included in the present application by way of reference.

Naturally, the roll-up window blind assembly according to FIG. 1 may also be used in a corresponding manner for covering a rear window of a vehicle.

The blind material is wound onto a cylindrical winding body, which is housed rotatably around winding axis 5 in a roll-up window blind box 4 that is provided in the door's top shoulder region and is covered or held, for example, by a door trim panel or an inner door skin. The winding body is pretensioned against the blind material's drawing-off direction such that the blind material is held under tension in every position of roll-up window blind 1. According to FIG. 1, pull rod 6, which consists of a semi-circular rod or similar with a bending-resistant cross-section, is joined in region 20 to a pull rod 7 which is joined to the upper edge of roll-up window blind 1. By moving tab 31 upwards, pressing rod 6 is moved upwards as a result of which pull rod 7 is pushed upwards and in this manner roll-up window blind 1 is drawn off the winding body.

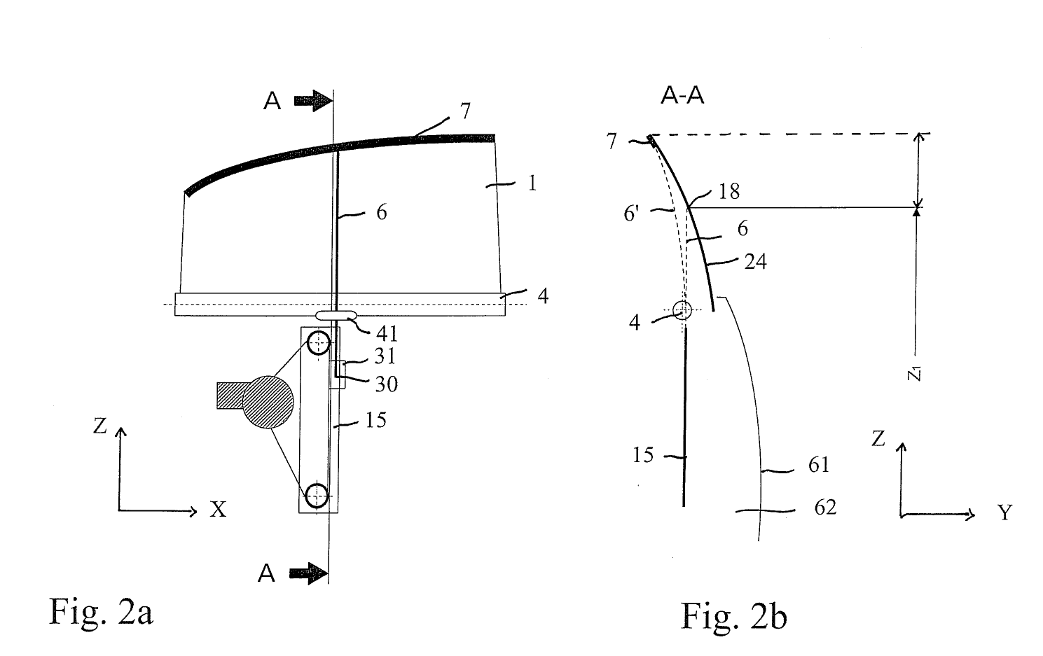

According to FIGS. 2a and 2b, guide rail 15 is housed in a straight line and vertically in the door interior 62 of a vehicle door. According to FIG. 2b, window pane 24 is curved outwards from the vehicle. In the bottom-most limit position of tab 31, pressing rod 6 is aligned parallel to guide rail 15. Pull rod 6 is constantly guided by a slot 41, which may be provided or formed on the base of roll-up window blind box 4, in the door body shell, in a door trim panel or at the upper end of guide rail 15. In direction y transverse to the vehicle, the slot has a lateral dimension which corresponds to a lateral dimension of pressing rod 6 in this direction such that pressing rod 6 is guided in close contact in the transverse direction of the vehicle. In direction x longitudinal to the vehicle, however, slot 41 has a certain elongation such that pressing rod 6 is guided in slot 41 with play. In the embodiment according to FIGS. 2a and 2b, no lateral guide rails are provided for guidance of roll-up window blind 1 although these may be provided additionally according to an alternative embodiment.

According to FIG. 2b, the upper end of pressing rod 6 is moved upwards as tab 31 moves upwards parallel to guide rail 15 until said end comes into contact with window pane 24 in region 18. A certain bendability of pull rod 7 may ensure that pull rod 7 is in contact with window pane 24 over a linear region 18 running substantially horizontally. In this position, contact region 18, pressing rod 6 and slot 41 are aligned in vertical direction z along a common line. In the embodiment according to FIG. 2b, pressing rod 6 is to certain degree elastic such that, on further raising of tab 31, pressing rod 6 is further moved along and in contact with window pane 24. In this regard there is an increasing elastic deformation of the pressure rod, as indicated by reference numeral 6′ in FIG. 2b. Finally, the top end position according to FIG. 2b is reached, in which elastically bent pressing rod 6′ projects to a maximum out of slot 41 and is curved evenly up to the upper edge of window pane 24. Thus on reaching a height level z₁, corresponding to contact region 18, and on further drawing-off of roll-up window blind 1, fluttering or vibration of roll-up window blind 1 is reliably prevented. In this regard, the vibration behavior of roll-up window blind 1 is substantially predetermined by the size, dimensions and torsional characteristics of the web material of roll-up window blind 1 as well as by the bendability of pressing rod 6 and the characteristics of pull rod 7 and may be adapted to the specifications in a simple manner.

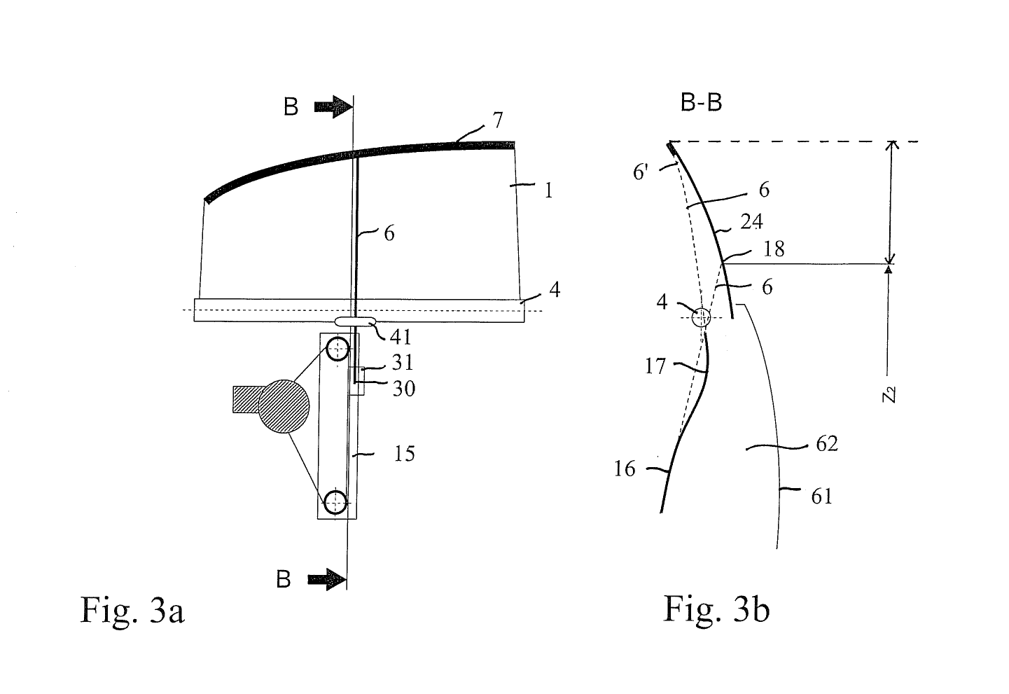

FIGS. 3a and 3b show a further embodiment in which the guide rail has a rectilinear guide section 16 which runs at an angle towards window pane 24 and has a curved guide section 17.

According to FIG. 3b, an imaginary elongation line of rectilinear section 16 cuts window pane 24 in region 18. According to FIG. 3b, pressing rod 6 extends substantially along the imaginary extension line of the rectilinear guide section as indicated by the dotted line. By comparison with FIG. 2b, it is apparent that the upper end of pressing rod 6 or the pull rod comes into contact with window pane 24 much earlier on drawing-off of the roll-up window blind. During the further upward movement of tab 31, said tab and the lower end of pressing rod 6 linked to tab 31 initially moves away from the imaginary extension line and then back towards it in the manner of a connecting member. By co-operation of pressing rod 6 with slot 41, the path of the upper end of pressing rod 6 or of pull rod 7 is controlled during further drawing-off of the blind material. Starting with the contact of the upper end of pressing rod 6 or of pull rod 7 on window pane 24, said end or said rod may be guided along the entire drawing-off path in contact with window pane 24. According to an alternative embodiment, the upper end of pressing rod 6 or pull rod 7 may be guided at a very small distance from window pane 24, following the curve of window pane 24, as controlled by the co-operation of pressing rod 6 with slot 41. In the topmost end position, the upper end of pressing rod 6 may be elastically deformed or bent, as indicated by reference numeral 6′ in FIG. 3b. Fluttering or vibration of the blind material is reliably prevented in any height position of the roll-up window blind after reaching height position z₂ by means of the aforementioned control of the drawing-off path.

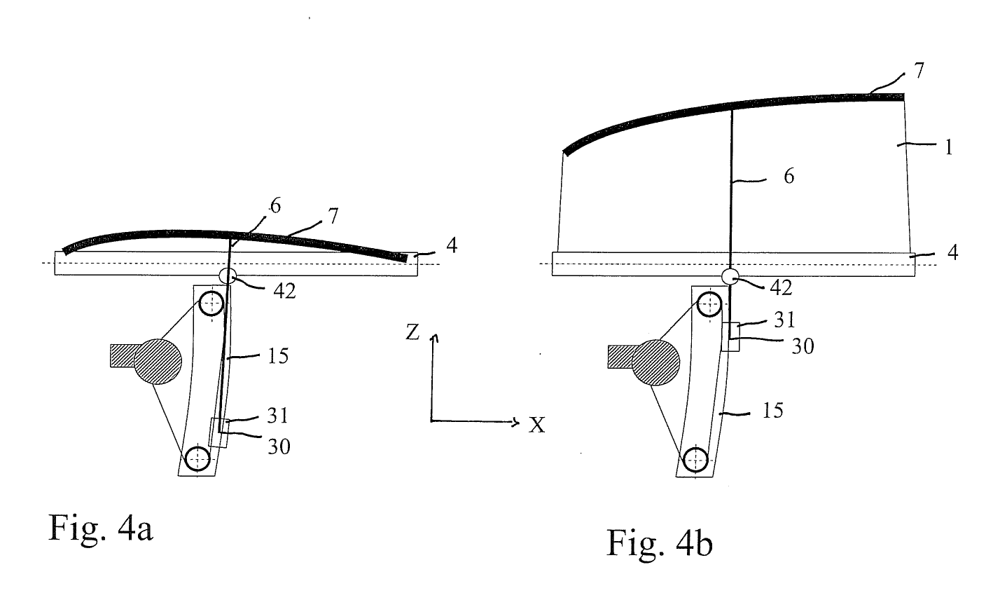

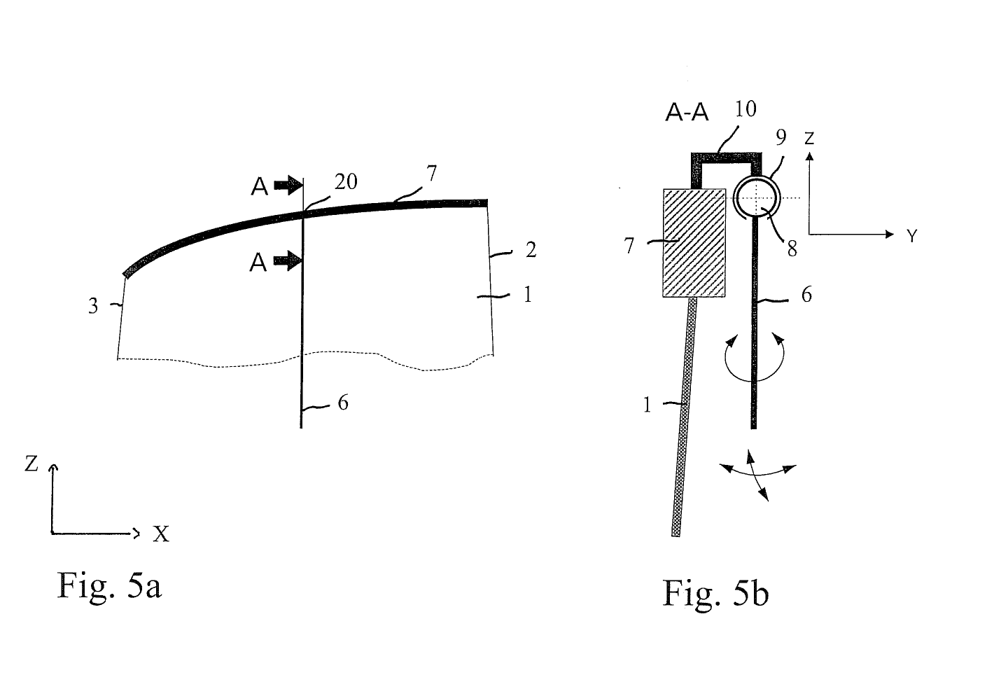

According to a further embodiment, as shown in FIGS. 4a and 4b, guide rail 15 is curved in the x, z plane additionally to the curvature previously described on the basis of FIGS. 3a and 3b or as an alternative to this curvature. As a result, tab 31 is additionally or alternatively guided in its path in longitudinal direction x of the vehicle and drawing-off direction z of roll-up window blind 1. In this regard, the path guidance is controlled by the co-operation of pressing rod 6 with a hole 42, which is formed corresponding to the cross-section of pressing rod 6 and in which pressing rod 6 is guided in close contact and so as to be slidably moveable. Hole 42 is preferably formed as a round hole. This embodiment is particularly practicable with simultaneous use of a compensation means, as described subsequently on the basis of FIGS. 5a to 8c, in order to ensure crease-free reeling out and reeling in of the roll-up window blind onto the winding body.

In the embodiment according to FIGS. 5a and 5b, pressing rod 6 is connected to roll-up window blind 1 by way of a ball joint 8, 9 and by way of a bracket 10 and a joining section 7. Ball joint 8, 9 ensures compensation such that roll-up window blind 1 can be reeled out from the winding body and reeled back onto it crease-free at any height level. In this regard, roll-up window blind 1 is kept sufficiently under tension due to the elasticity of pull rod 7. As shown in FIG. 5b, pressing rod 6 may be pivoted in spatial directions x, y and rotated around its longitudinal axis z in order to bring about the aforementioned compensation.

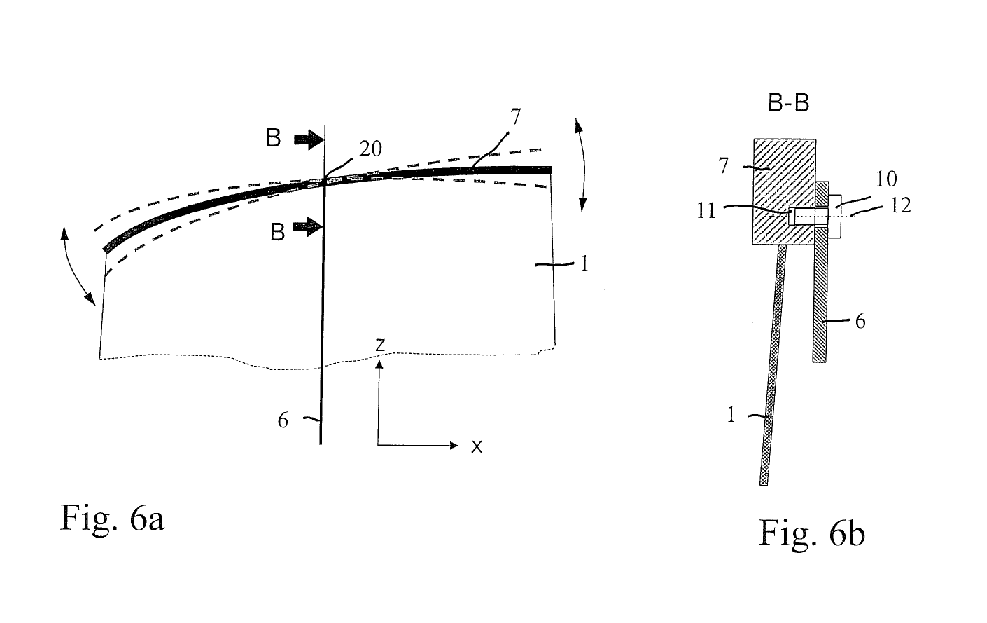

In another embodiment according to FIGS. 6a and 6b, pressing rod 6 is connected to joining section 7 by way of a spigot 10, whereby spigot 10 is rotatably supported around the pivot axis extending in the transverse direction of the vehicle in spigot receptacle 11 formed in joining section 7. This results in a pivotability of pull rod 7 in relation to pressing rod 6 as indicated by the arrows and dotted lines in FIG. 6a. In this regard, a certain elasticity of pull rod 7 can further assist the aforementioned compensation.

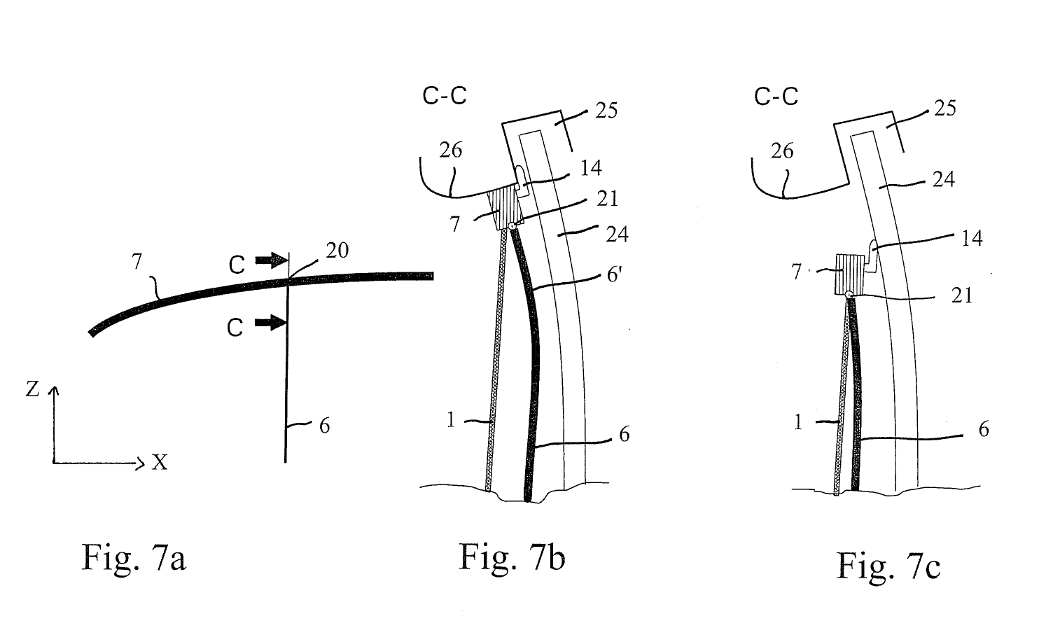

In the embodiment according to FIGS. 7a to 7c, the upper section of pressing rod 6 is elastically deformable, as indicated by reference numeral 6′, such that a securing hook 14 formed on joining section 7 is pretensioned against an edge, which is formed on the transition region between door frame 26 and window pane receptacle 25, in order to engage behind said edge and thus to latch or secure the topmost end position of roll-up window blind 1.

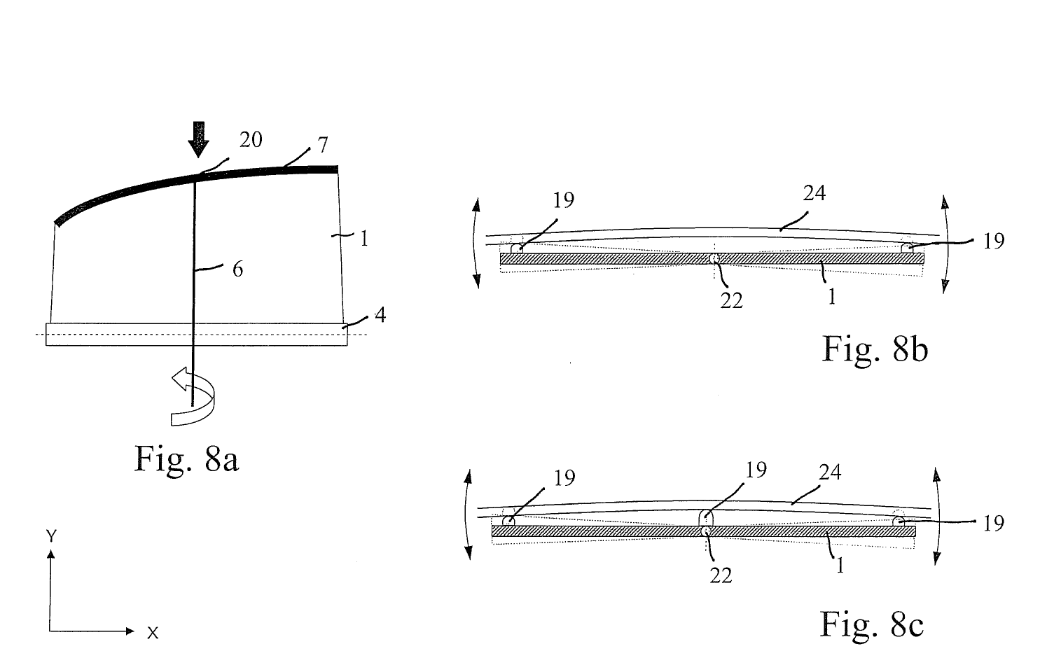

FIGS. 8a to 8c show a further embodiment in which pull rod 7 can be rotated around the longitudinal axis of pressing rod 6 in upper joining region 20 such that edge regions of roll-up window blind 1 are always guided in contact with window pane 24. To reduce friction, in this and also in a supplementary manner, if desired, in all other embodiments, sliding elements 19 are provided on the upper edge of roll-up window blind 1, for example on the outside of pull rod 7, which ensure a favorable tribological pairing with window pane 24. According to FIG. 8c, in addition a further sliding element 19 is also provided in the region of pivot axis 22, preferably on the outside of pull rod 7, said piece being longer in the transverse direction of the vehicle due to the curvature of window pane 24 in the vehicle's longitudinal direction. Alternatively or in a supplementary manner, pull rod 7 may also be sufficiently elastic to also be guided closer to window pane 24 in the region of pivot axis 22.

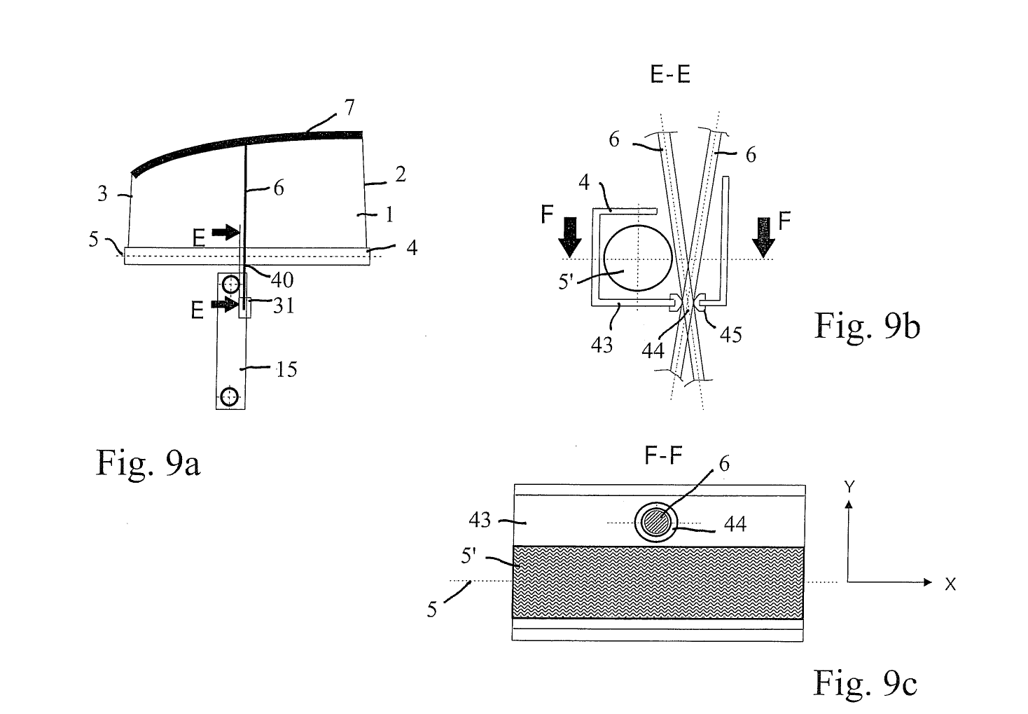

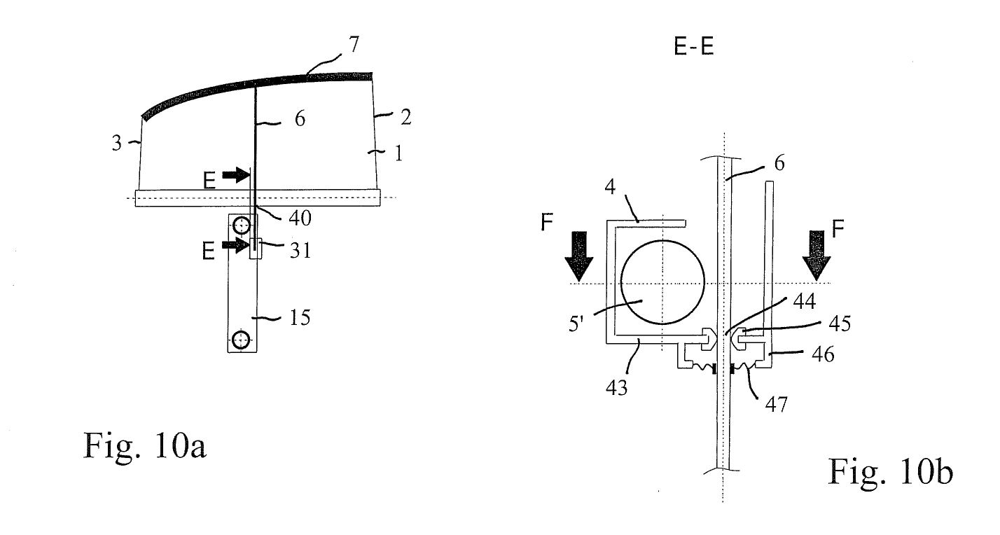

FIGS. 9a to 9c show a further embodiment in which pressing rod guide 40 is formed in the shape of a slot or round hole in base 43 of roll-up window blind box 4. At the same time, a marginal cover or sliding guide 45 ensures an appropriate tribological pairing with the material of pressing rod 6 guided therein. According to FIG. 9c, pressing rod 6 is accommodated and guided in close contact in round hole 44 in base 43 of the roll-up window blind box. Due to a curvature of the guide rail, as previously described on the basis of FIGS. 3a to 4b, pressing rod 6 is deflected on drawing off the roll-up window blind in the vehicle's transverse direction and/or the vehicle's longitudinal direction, as indicated in FIG. 9b by two different alignments of pressing rod 6. In the embodiment according to FIG. 9b, the wall cover 45 may provide for a certain sealing of the round hole or slot in base 43 of roll-up window blind box 4 in relation to roll-up window blind 1. Additionally, however, as indicated in FIG. 10b, a sealing grommet 47 may be supported on an extension 46 projecting up from base 43 in the region of round hole or slot 44 in order to provide an even better sealing of the blind material in relation to roll-up window blind box 4. In such a case, roll-up window blind box 4 may also be disposed on the wet space side of a vehicle door although such a sealing may also be omitted where the roll-up window blind box is disposed on the dry space side of a vehicle door.

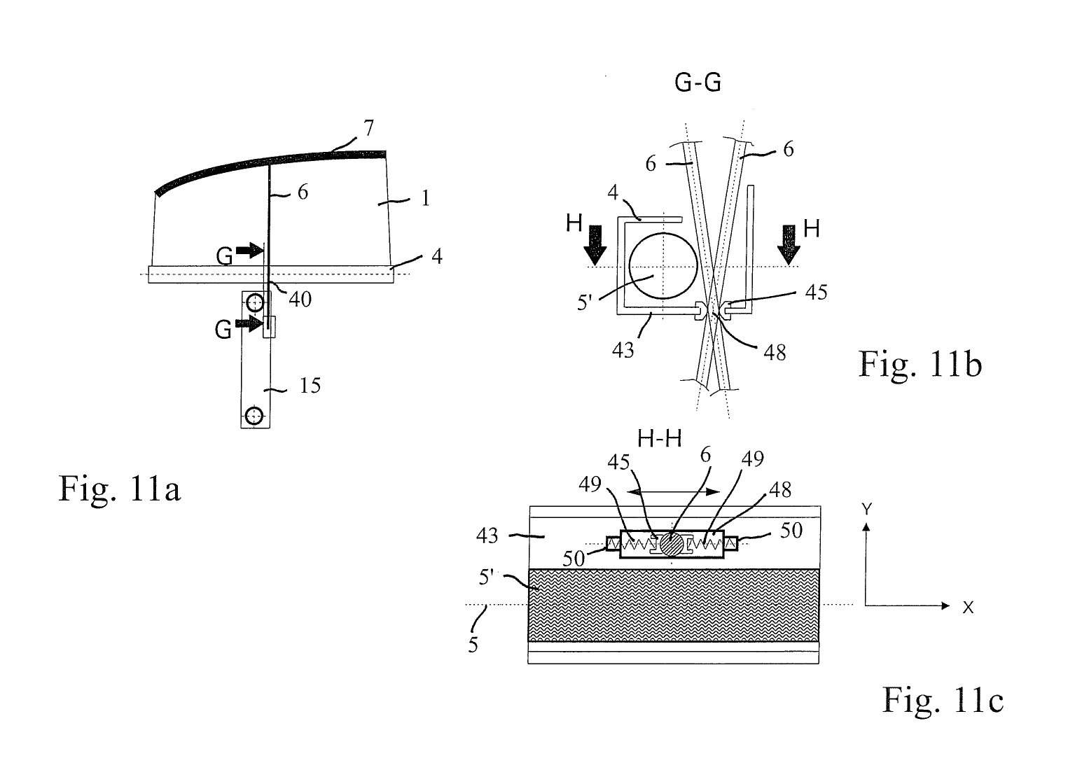

In the embodiment according to FIGS. 11a to 11c, in base 43 is formed a rectangular slot 48, the dimensions of which correspond to the maximum lateral dimension of pressing rod 6 in the vehicle's transverse direction, and which ensures a certain play of pressing rod 6 in the vehicle's longitudinal direction. As shown in FIG. 11c, according to a further embodiment, pressing rod 6 is accommodated in close contact in a sliding element 45, which is resiliently supported in slot 48 in the vehicle's longitudinal direction. For this purpose, two pressure springs are accommodated in spring receptacles formed laterally on slot 48, said receptacles resiliently supporting sliding element 45. This prevents undesirable vibration of pressing rod 6 in slot 48 and brings about reliable guidance of pressing rod 6.

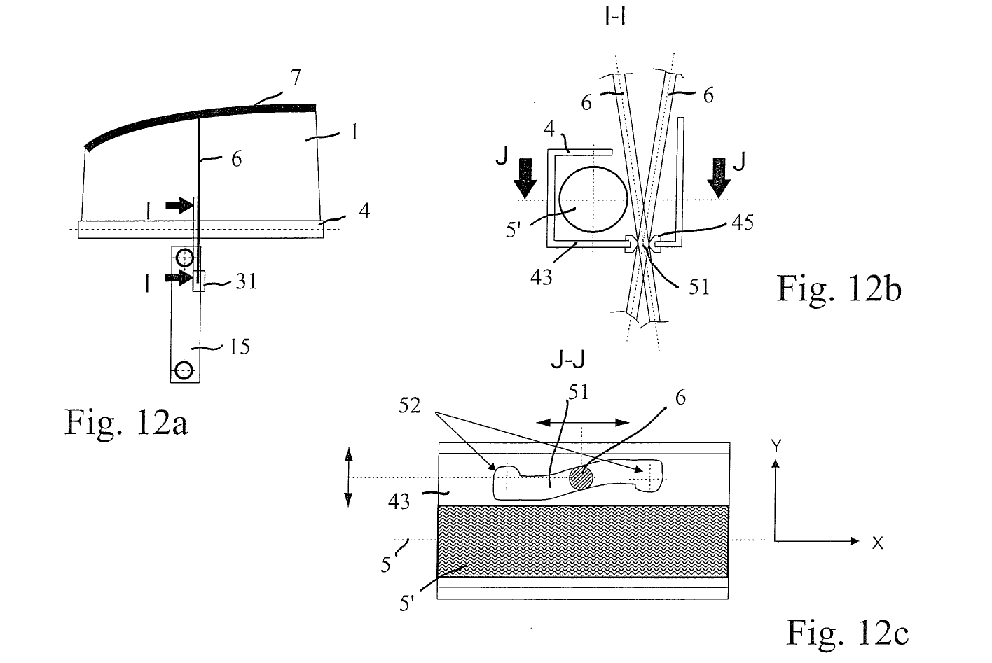

In the embodiment according to FIGS. 12a to 12c, the slot formed in base 43 of roll-up window blind box 4 is curved in an S-shaped manner such that pressing rod 6 is guided in the manner of a connecting member on drawing off roll-up window blind 1 in longitudinal direction x of the vehicle and transverse direction y of the vehicle. According to FIG. 12c, the width of slot 51 in transverse direction y of the vehicle corresponds to the lateral dimension of pressing rod 6 such that said rod is guided in close contact in slot 51. According to FIG. 12c, on both end regions, alternatively also on only one end region, are formed locking sections 52 projecting in the shape of hooks from guide aperture 51, in which sections pressing rod 6 can be held securely. Preferably, pressing rod 6 runs into aforementioned end regions 52 on reaching the bottom-most and topmost end position of roll-up window blind 1.

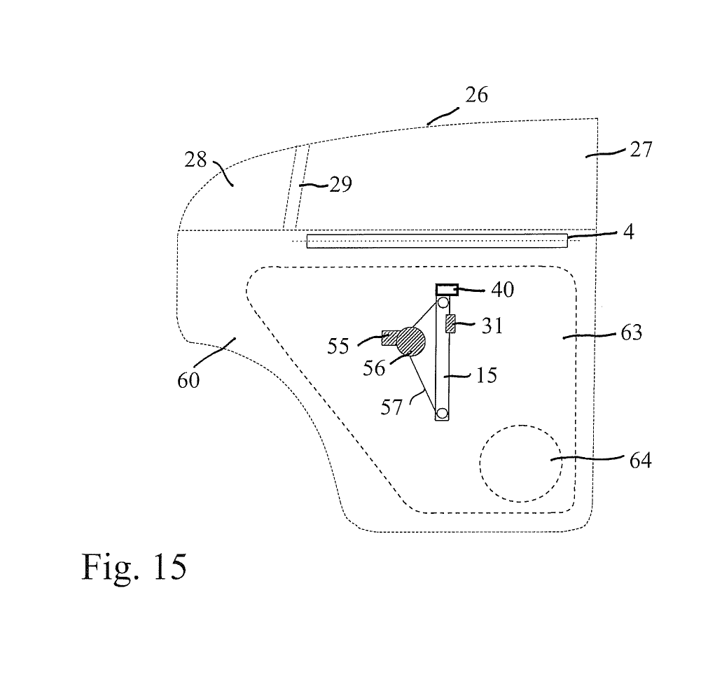

As will immediately be obvious to the person of average skill in the art on studying the previous embodiments, the aforementioned guide means formed as a round hole or slot may also be formed so as to be open on one side in the shape of an appropriate recess. Alternatively, such a guide means may also be formed as a closed eye or an eye open on one side, as described subsequently on the basis of FIGS. 13 and 15.

FIG. 13 shows a vehicle door 60 with a height-adjustable side window 27 which is separated from triangular side window 28 which is not supposed to be height-adjustable. Roll-up window blind box 4 extends over the length of height-adjustable side window 27. By appropriate design of the roll-up window blind it is, however, possible to ensure privacy or protection against glare in the region of triangular-shaped side window 28. According to FIG. 13, the cable window lift serving to adjust the roll-up window blind is installed on a backing plate 63, which may also serve for the pre-assembly of further functional components such as operating unit, side airbag module, window lift, speaker (in speaker aperture 64 formed in backing plate 62) or similar and which in the assembled state seals an installation aperture formed in vehicle door 60 in order to ensure a separation between the wet space and the dry space in vehicle door 60 in the known manner. According to FIG. 13, a pressing rod guide 40 is formed or provided as an eye or lug directly on backing plate 63 which may be implemented easily by stamping and embossing of a metal sheet as a backing plate or by one-piece injection molding or by injection molding attachment in the case of a backing plate 63 formed from a plastic. Alternatively, such a pressing rod guide 40 may also be attached to backing plate 63. Pressing rod guide 40 forms a round hole or a slot, as previously described on the basis of FIGS. 2a to 12c.

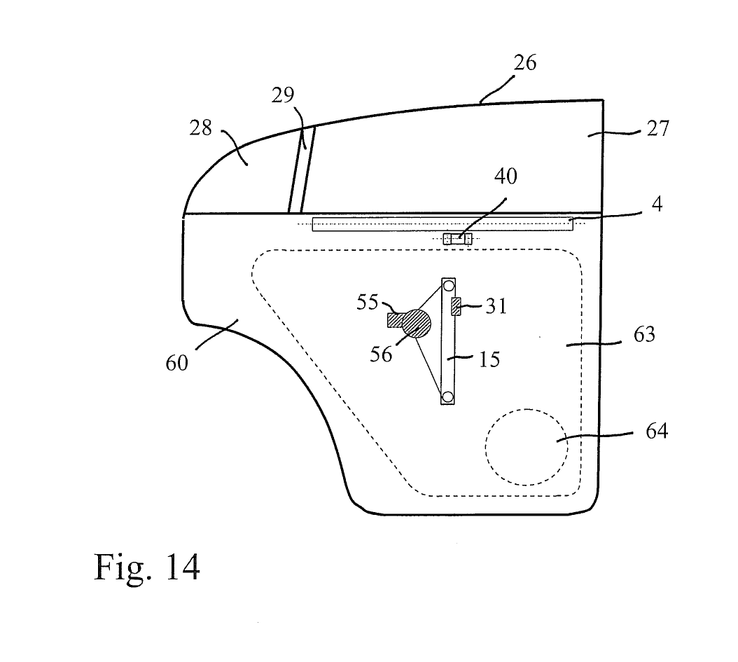

In the embodiment according to FIG. 14, such an eye or lug acting as a pressing rod guide 40 is provided or formed directly on the inner door skin of vehicle door 60.

In the embodiment according to FIG. 15, pressing rod guide 40 is formed or provided directly on the upper end of guide rail 15, for example in the shape of an appropriate clip or eye or also by integration into a runner-like cable deflection piece via which control cable 57 is guided.

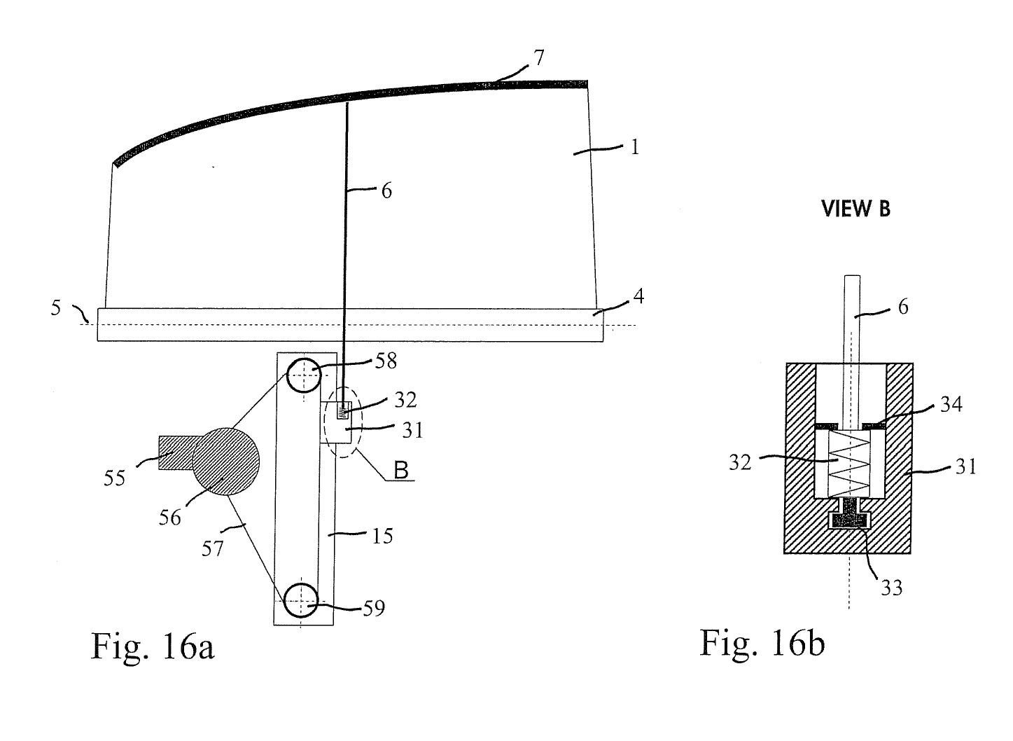

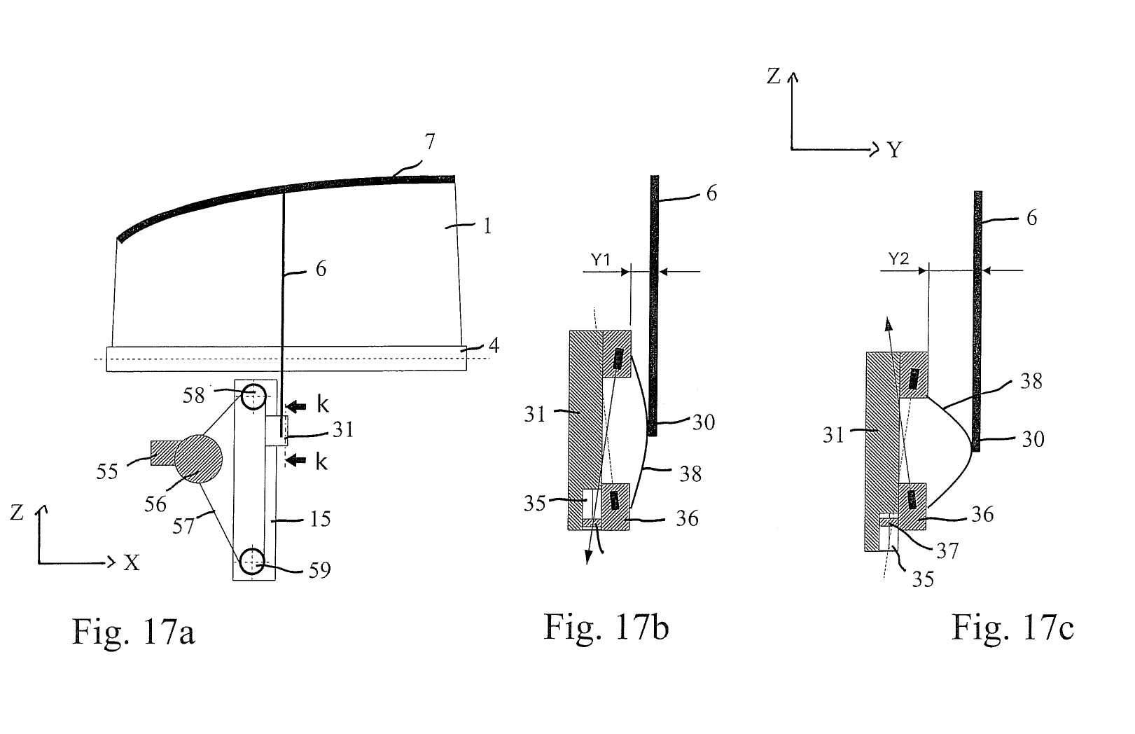

A damping of top and/or bottom end positions of the roll-up window blind is described subsequently on the basis of FIGS. 16 and 17. According to FIGS. 16a and 16b, the lower end of pressing rod 6 is resiliently supported in tab 31 movably guided in guide rail 15. For this purpose, a spring receptacle 33 is formed in tab 31, in which receptacle a pressure spring 32 is accommodated, which is accommodated under pretension by a limit stop 34 and which is joined to the lower end of pressing rod 6. On reaching the top end position of roll-up window blind 1, as shown by way of example in FIG. 7b, in this embodiment the lower end of pressing rod 6 is pushed further downwards into tab 31 until tab 31 reaches its bottom end position. In such an embodiment, pressing rod 6 need not be elastic and may have a greater bending resistance in order to thus counteract undesirable fluttering or vibration of roll-up window blind 1 even more effectively.

In the embodiment according to FIGS. 17a to 17c, tab 31 has a receptacle 35, in which a nose 37 of a movable tab section 36 is movably supported. The basic body of tab 31 and movable tab section 36 are joined to one another by way of leaf spring 38 and are pretensioned against each other. The lower end of pressing rod 6 is connected thereto in the bending region of leaf spring 38. On reaching the top or bottom end position of roll-up window blind 1 and on further upwards or downwards movements of tab 31, eventually movable tab section 36 is moved relative to the basic body of tab 31 against the restoring force exerted by leaf spring 38. In the process there is a deflection of the lower end of pressing rod 6 in transverse direction of the vehicle y. Limit stop damping for roll-up window blind 1 is brought about in this manner. In co-operation with a pressing rod guide, as described previously, formed for example as a round hole or slot, deflection of the lower end of pressing rod 6 can also effectively assist an engagement of a locking hook provided on pull rod 7 or on the upper edge of roll-up window blind 1, as was described by way of example on the basis of FIGS. 7b and 7c. In such a case, pressing rod 6 need not be elastic or may be more bending-resistant in order to counteract undesirable fluttering or vibration of roll-up window blind 1 even more effectively.

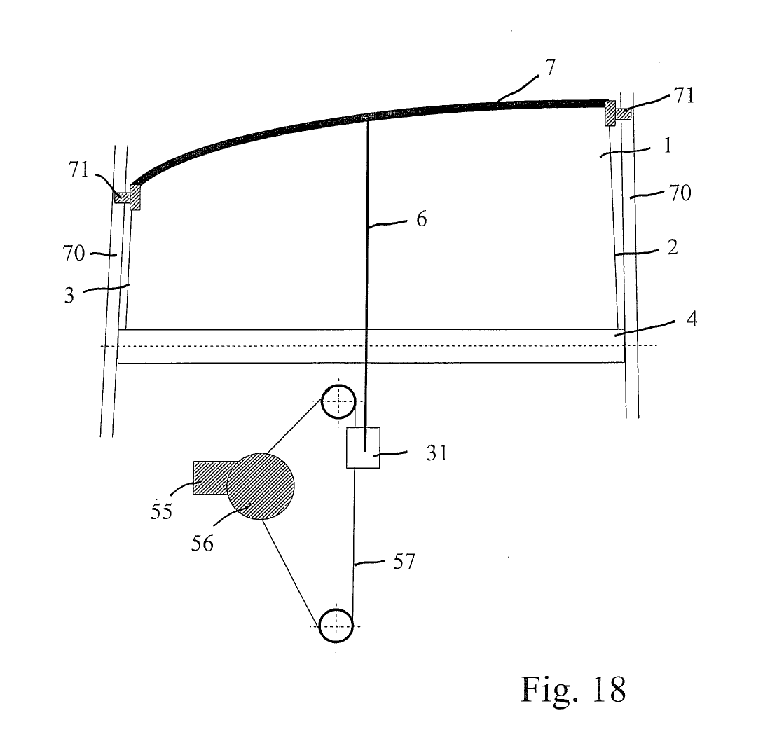

As will immediately be obvious to the person of average skill in the art on studying the previous description, roll-up window blind 1 may also be guided in a supplementary manner or alternatively by means of guide rails 70 provided laterally on the window pane, as shown schematically in FIG. 18. In this embodiment, the cable window lift has no guide rail although this may also be provided in principle. According to FIG. 18, provided at the upper end of marginal areas 2, 3 of roll-up window blind 1 are guide spigots 71, which engage in lateral guide rails 70 and are guided movably therein.

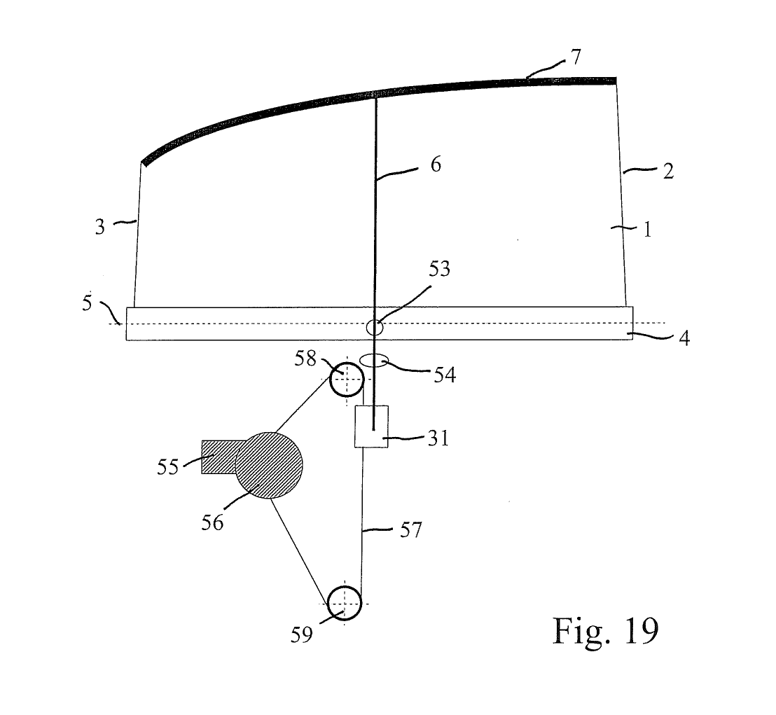

As indicated schematically in FIG. 19, according to the invention it is also possible, as described previously, to combine two pressing rod guides with one another as indicated schematically by round hole 53 and slot 54 illustrated in FIG. 19, which may be provided at one of the positions described previously on the basis of FIGS. 13 to 16. In this regard, round hole 53 serves to secure the position of the pressing rod in longitudinal direction x of the vehicle and transverse direction of the vehicle y, whilst slot 54 serves to secure the position of pressing rod 6 only in transverse direction y of the vehicle but not in longitudinal direction x of the vehicle and in fact at a different height level along the movement path of pressing rod 6. In this manner there are different degrees of freedom available for controlling the drawing-off path of roll-up window blind 1 such that roll-up window blind 1 can also be path-guided three-dimensionally in any manner.

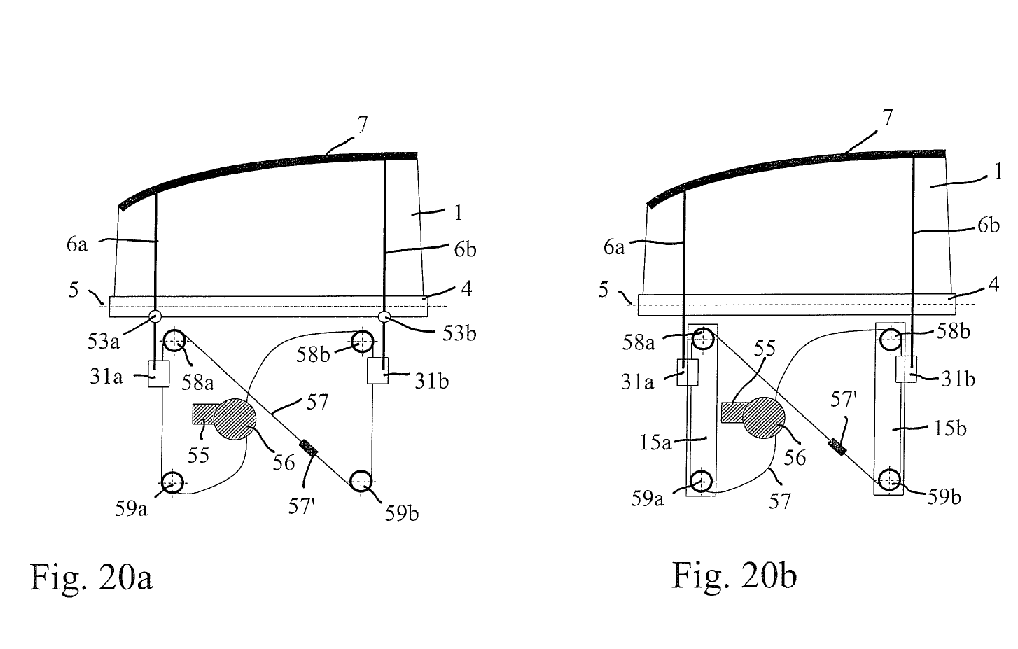

As shown in FIG. 20a, the cable window lift can also adjust two tabs 31a, 31b which are each connected to a pressing rod 6a, 6b in the manner described previously. According to FIG. 20a, control cable loop 57 of the cable window lift is closed. In order to compensate an unequal lift of tabs 31a, 31b, particularly on reaching a top or bottom end position of roll-up window blind 1, control cable loop 57 is closed by way of a sufficiently tensioned tension spring 57′, which provides for a certain compensation of the cable lengths.

As indicated in FIG. 20b, such a cable window lift may also, of course, be formed as two strands, with a left-hand guide rail 15a and a right-hand guide rail 15b for guiding tabs 31a, 31b.

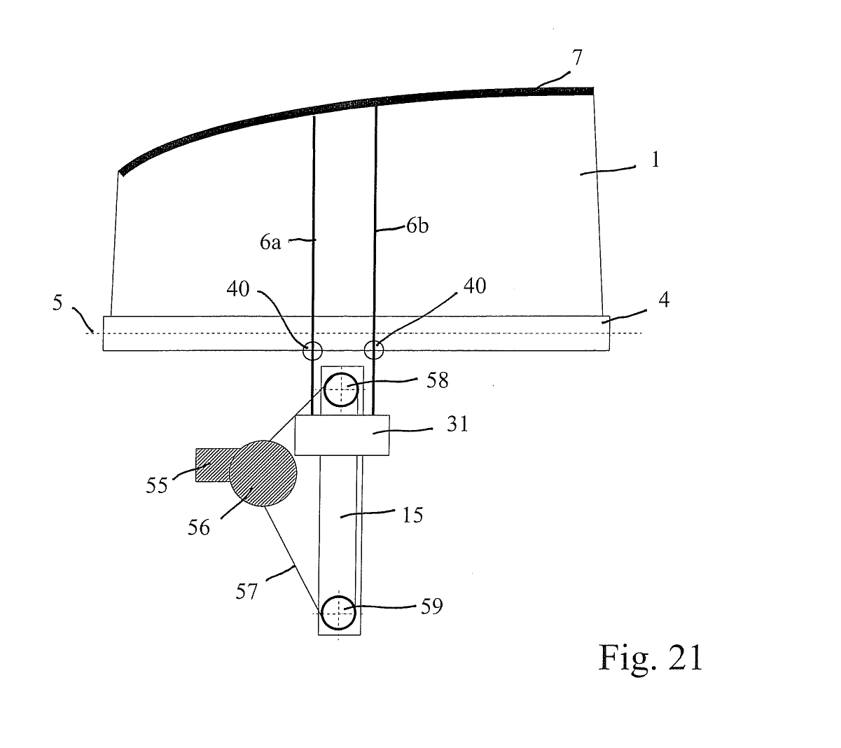

FIG. 21 shows a further embodiment, in which the length of tab 31 is sufficient in longitudinal direction x of the vehicle to support two pressure rods 6a, 6b.

As will immediately be obvious to the person of average skill in the art on studying the previous description, the invention includes numerous inventive aspects also capable of being claimed independently and patented since they are novel and inventive, in particular: the early contact of the pressing rod after exiting out of/from the roll-up window blind box in order to prevent vibration during travel; a corresponding guidance of the pressure rod; a resiliently supported tab; a path-guidance of the tab in a plane which is spanned by a longitudinal direction of the vehicle and by the drawing-off direction of the roll-up window blind; various possibilities for supporting and guiding the pressure rod; plus the integration of such a support or guidance in components of a vehicle chassis or vehicle door. According to the present invention it should be expressly possible to combine these inventive aspects with one another in any manner.

Although the invention has previously been described on the basis of a cable window lift, it will immediately be obvious to a person of average skill in the art that the invention can also be applied in a corresponding manner using Bowden cable window lifts. A toothed rod or spindle, which is disposed underneath the roll-up window blind or is provided in duplicate in a symmetrical arrangement, may also serve as an alternative for adjusting the pressure rod.

### LIST OF REFERENCE NUMBERS

1 Roll-up window blind
2 Front edge of the roll-up window blind
3 Rear edge of the roll-up window blind
4 Roll-up window blind box
5 Winding axis
6 Winding body
6, 6a, 6b Pressure rod
6′ Deformed area of pressure rod
7 Pull rod/Pull bow
8 Spherical head
9 Spherical head receptacle
10 Bracket
11 Spigot
12 Spigot receptacle
13 Pivot axis
14 Hook
15 Guide rail
16 Straight section of guide rail 15
17 Curved section of guide rail 15
18 Lower contact region of pull bow 7 on window pane
19 Sliding element
20 Upper joining region
21 Rotary axis
22 Swivel axis
24 Window pane
25 Window pane receptacle
26 Door frame
27 Height-adjustable side window
28 Triangular side window
29 Intermediate ligament
30 Lower joining region
31 Tab
32 Spring
33 Spring receptacle
34 Limit stop
35 Guide
36 Movable tab section
37 Nose
38 Leaf spring
40 Pressing rod guide
41 Slot
42 Round hole
43 Base of roll-up window blind box 4
44 Round hole
45 Edge cover/Sliding guide
46 Extension
47 Sealing grommet
48 Slot
49 Spring
50 Spring receptacle
51 Guide aperture
52 Locking section
53 x, y guide
54 y guide
55 Window lift drive
56 Cable drum
57 Control cable
57′ Tension spring
58 Top cable deflection roller
59 Bottom cable deflection roller
60 Vehicle door
61 Door skin
62 Door interior
63 Backing plate
64 Speaker aperture
70 Guide rail
71 Spigot

What is claimed is:

1. A roll-up window blind assembly for motor vehicles, comprising:
a roll-up window blind in the region of a window pane to afford privacy or protection against glare; and
an adjusting mechanism for drawing off a blind material from a winding body; wherein
the adjusting mechanism is disposed underneath the window pane and is joined to the lower end of a power transmission means, the upper end of which is linked to a pull rod, said pull rod being joined to the top edge of the blind material in order to draw this off; and
a guide means is provided for guiding the power transmission means;
in which roll-up window blind assembly the guide means is configured to control a path of the power transmission means on drawing off the blind material such that, at the beginning of drawing the blind material off the winding body, the upper end of the power transmission means moves towards the window pane or is brought into contact with it and moves along the window pane or continues to be held in contact with it on further drawing-off of the blind material.

2. The roll-up window blind assembly according to claim 1, wherein the power transmission means comprises a pressure rod, which is pretensioned elastically or towards the window pane, and wherein the window pane is curved outwards from the vehicle and, at the beginning of drawing off the blind material, the upper end of the pressing rod is moved towards a region of the window pane close to its bottom edge or is brought into contact with this region.

3. The roll-up window blind assembly according to claim 2, wherein at least one sliding element is provided on at least one of the upper end of the pressing rod and of the pull rod connected thereto and of the upper edge of the blind material for support against the window pane during further drawing-off of the blind material.

4. The roll-up window blind assembly according to claim 3, wherein the guide means comprises a slot or an oblong eye, which extends in a first direction parallel to or along the window pane and in a second direction, perpendicular to the first direction, having a lateral dimension that corresponds to a lateral dimension of the pressing rod in the second direction.

5. The roll-up window blind assembly according to claim 4, wherein a sliding element is provided in the slot or oblong eye, said sliding element correspondingly accommodating the pressing rod and guiding it during further drawing-off of the blind material.

6. The roll-up window blind assembly according to claim 5, wherein the sliding element is movably supported in the slot or the oblong eye against a restoring force in the first direction.

7. The roll-up window blind assembly according to claim 4, wherein the course of the slot or oblong eye is curved in the second direction.

8. The roll-up window blind assembly according to claim 7, wherein at least one end region of the slot or the oblong eye is formed in the shape of a hook in order, by securing or locking of the pressure rod's position in the first and second direction, to ensure or maintain a position or pretensioning of at least one of the pressing rod and of the pull rod relative to the window pane during further drawing-off of the blind material.

9. The roll-up window blind assembly according to claim 8, wherein the pressing rod is received in the end region in at least one of a topmost and of a bottom-most position of the roll-up window blind.

10. The roll-up window blind assembly according to claim 1, wherein
the guide means comprises one of a hole, a round hole and an eye;
the pressing rod on drawing-off of the blind material is guided so as to be slidably movable and in close contact; and
a compensation means is provided in order to prevent excessive contact pressure of at least one of the pressing rod and of the pull rod on the window pane during further drawing-off of the blind material.

11. The roll-up window blind assembly according to claim 1, wherein the guide means further comprises at least one guide rail, which is formed so as to be curved at least in sections, such that, at the beginning of drawing the blind material off the winding body, the upper end of the pressing rod moves towards the window pane or is brought into contact with it and moves along the window pane or continues to be held in contact with it on further drawing-off of the blind material.

12. The roll-up window blind assembly according to claim 11, wherein the guide rail has a lower guide section, the imaginary extension of which cuts the window pane, and an upper section curved towards the outside of the vehicle.

13. The roll-up window blind assembly according to claim 12, wherein an upper end of the guide rail cuts the imaginary extension of the straight section.

14. The roll-up window blind assembly according to claim 11, wherein the guide rail guides a tab of the adjusting mechanism.

15. The roll-up window blind assembly according to claim 11, wherein the guide rail guides sliding elements, which are formed as guide spigots, provided laterally on the upper edge of the blind material.

16. The roll-up window blind assembly according to claim 4, wherein the hole or slot is formed in the base of a roll-up window blind box in which the winding body is supported so as to be rotatably movable.

17. The roll-up window blind assembly according to claim 16, wherein a sealing member is provided on the base of the roll-up window blind box, said sealing member sealing the blind material against a margin of the hole or slot.

18. The roll-up window blind assembly according to claim 4, wherein the hole or slot is integrated into a guide rail of the adjusting mechanism.

19. The roll-up window blind assembly according to claim 4, wherein the eye or oblong eye is provided on or formed in an inner skin of one of a vehicle door, a door module member of a vehicle door and a door trim panel of a vehicle door.

20. The roll-up window blind assembly according to claim 1, further comprising a compensation means in order to prevent excessive contact pressure of at least one of the pressing rod and of the pull rod on the window pane on further drawing-off of the blind material.

21. The roll-up window blind assembly according to claim 20, wherein the compensation means comprises a ball joint on the upper end of the power transmission means such that the pull rod is at least one of rotatable around the power transmission means and pivotable around axes perpendicular thereto.

22. The roll-up window blind assembly according to claim 21, wherein the power transmission means is joined to the upper edge of the blind material by way of a bracket extending outwards from the vehicle, wherein the ball joint is provided at one end of the bracket and the blind material is provided at the other end of the bracket.

23. The roll-up window blind assembly according to claim 20, wherein the compensation means comprises a spigot, which is supported so as to be rotatably movable on the upper edge of the blind material and which joins said blind material to the power transmission means.

24. The roll-up window blind assembly according to claim 1, wherein the pull rod is elastic and holds the blind material under elastic tension in a drawn-off state.

25. The roll-up window blind assembly according to claim 1, wherein the power transmission means is joined by way of a tab to the adjusting mechanism which resiliently supports the lower end of the power transmission means.

26. The roll-up window blind assembly according to claim 25, wherein the lower end of the power transmission means is resiliently supported in the blind material's drawing-off direction.

27. The roll-up window blind assembly according to claim 26, wherein the tab has a basic body and a body that is movable relative to said basic body in the blind material's drawing-of direction, said body being resiliently supported and linked to the lower end of the power transmission means.

28. The roll-up window blind assembly according to claim 27, wherein
the basic body and the movably supported body are pretensioned against one another by way of a leaf spring; and
the lower end of the power transmission means is joined to a bending section of the leaf spring such that the lower end of the power transmission means is deflectable towards the outside of the vehicle on drawing-off of the blind material.

29. The roll-up window blind assembly according to claim 1, wherein the adjusting mechanism is a cable or Bowden cable window lift.

30. The roll-up window blind assembly according to claim 29, wherein the cable or Bowden cable window lift has two guide rails, a tension spring being provided in a control cable loop of the cable or Bowden cable window lift.

31. The roll-up window blind assembly according to claim 29, wherein the cable or Bowden cable window lift drives two power transmission means at a distance from one another.

32. The roll-up window blind assembly according to claim 31, wherein both the power transmission means are supported on the same tab.

33. A roll-up window blind assembly for motor vehicles, comprising:
a roll-up window blind for privacy or protection against glare in a region of a window pane; and
an adjusting mechanism for drawing off a blind material from a winding body; wherein
the adjusting mechanism is a cable or Bowden cable window lift, which drives two power transmission means at a distance from one another, which is disposed underneath the window pane and which is joined to the lower end of a pressure rod, the upper end of which is linked to a pull rod, said pull rod being joined to the top edge of the blind material in order to draw said material off; and
at least one guide rail is provided, which is formed so as to be curved at least in sections and which co-operates with the pressing rod in order to control a path of the pressing rod on drawing-off of the blind material such that, at the beginning of drawing the blind material off the winding body, the upper end of the pressing rod moves towards the window pane or is brought into contact with it and moves along the window pane or continues to be held in contact with it on further drawing-off of the blind material.

34. The roll-up window blind assembly according to claim 33, wherein
assigned to each guide rail is one of a hole, a round hole and an eye, said the pressing rod being guided slidably and in close contact on drawing-off of the blind material; and
a compensating means is provided in order to prevent excessive contact pressure of at least one of the pressing rod and of the pull rod on the window pane during further drawing-off of the blind material.
